(19) United States
(12) Patent Application Publication
(10) Pub. No.: US 2023/0358596 A1
(43) Pub. Date: Nov. 9, 2023

(54) DIAGNOSTIC APPARATUS, MACHINING SYSTEM, DIAGNOSTIC METHOD, AND RECORDING MEDIUM

(71) Applicants: Osamu TAKEHIRA, Kanagawa (JP); Satoru GOTO, Kanagawa (JP)

(72) Inventors: Osamu TAKEHIRA, Kanagawa (JP); Satoru GOTO, Kanagawa (JP)

(73) Assignee: Ricoh Company, Ltd., Ohta-ku, Tokyo (JP)

(21) Appl. No.: 18/245,628

(22) PCT Filed: Oct. 13, 2021
(86) PCT No.: PCT/IB2021/059389

§ 371 Date: Mar. 16, 2023

(30) Foreign Application Priority Data
Oct. 29, 2020 (JP) 2020-181869

(51) Int. Cl. G01H 1/00; G01M 13/00

(52) U.S. Cl. CPC G01H 1/003; G01M 13/00

(57) ABSTRACT

A diagnostic apparatus includes a receiving unit to receive context information defining an operation of a tool of a machine, rotation information of a spindle, tool information, and a detection result of a time-varying physical quantity generated by the tool; a frequency analysis unit to frequency-analyze the detection result; a range setting unit to set a frequency range; a bandwidth setting unit to set a bandwidth of a noted frequency band in the frequency range; a band pass filter setting unit to set a band pass filter using center frequencies and the bandwidth; a feature information extraction unit to extract feature information from the detection result using the band pass filter and a frequency analysis result of the detection result; and a determining unit to determine a machining state using the feature information. The center frequencies are set using the rotation information, the tool information, and the frequency range.

### TECHNICAL FIELD

Embodiments of the present disclosure relate to a diagnostic apparatus, a machining system, a diagnostic method, and recording medium.

### BACKGROUND ART

There are diagnostic apparatuses for diagnosing whether a machining state of a machining machine is normal or abnormal. An example of the machining machine is a machining center that sequentially performs various types of machining while automatically replacing tools for the various types of machining. A diagnostic apparatus is used to interrupt the machining or issue an alert in accordance with a diagnostic result of the machining machine, so as to inhibit the production of a large number of defective products due to abnormal machining and prevent outflow of the defective products.

Patent Literature (PTL) 1 discloses the following diagnostic technology. Context information is acquired from a machine tool in advance, and a model learned from physical quantity data acquired by a sensor is generated for each operation state of the machine tool based on the context information. The context information acquired from the machine tool and the physical quantity data acquired by the sensor are applied to the model, to acquire a score. In diagnosing the machine tool, the score is compared with a preset threshold for determining whether the machining of the machine tool is normal or abnormal.

PTL 2 relates to a method and an apparatus for monitoring a state of a tool of, in particular, a milling machine. When cutting edges are normal, loads corresponding to the cutting edges are uniform. Even one cutting edge is incomplete (worn or damaged), the loads on the cutting edges are uneven, causing a change in the vibration. In order to distinguish an incomplete state from a corresponding change in the vibration, PTL 2 discloses a technology of passing a signal of an accelerometer disposed on a table frame of a machine through a plurality of adjustable band pass filters, comparing the acquired signal with a reference level, and outputting an alarm signal when the deviation is unacceptable.

PTL 3 relates to an abnormality detection method and an abnormality detection device for a rotary tool in cutting by a numerical control (NC) machine tool with an automatic tool changer. PTL 3 discloses a technology of detecting a cutting force, performing frequency analysis of a cutting force signal, calculating a ratio between a voltage level of a frequency corresponding to multiplication of the spindle rotation speed with the number of edges and a voltage level of a frequency corresponding to the spindle rotation speed, detecting the magnitude of runout of the rotary tool, and generating an abnormality signal when the magnitude exceeds a predetermined threshold value.

### CITATION LIST

### Patent Literature

[PTL 1]
   Japanese Patent No. 6156566
[PTL 2]
   Japanese Translation of PCT International Application Publication JP-T-58-500605
[PTL 3]
   Japanese Unexamined Patent Application Publication No. H09-174383

### SUMMARY OF INVENTION

### Technical Problem

However, when machining is performed in a state in which the cutting edge of the tool is damaged (e.g., chipped), a machining dimension deviates from a tolerance, resulting in a defective product. Since the defect occurs suddenly or accidentally, prevention of the defect in advance is difficult. Further, during replacement of the tool, if chips enter in a gap between a tapered portion of a tool holder and the spindle and are chucked, the runout of the cutting edge increases. Machining performed in this state generates defective products. There are technologies for detecting the runout of a cutting edge before performing machining and immediately after replacement of the tool, in order to avoid the production of defective products. However, addition of a new process inevitably lowers the productivity.

Therefore, for reducing the total production cost, in some cases, preventing the outflow of defective products or preventing continuous generation of defective products is more effective than taking countermeasures against unexpected or accidental machining defects. A machining center automates production that involves various types of machining using a plurality of tools, thereby improving the productivity. In order to diagnose an abnormality in a machining state that causes a defective product as described above, improvement is desired in the accuracy of abnormality determination in accordance with each machining state.

In view of the above, an object of the present disclosure is to provide a diagnostic apparatus, a machining system, a diagnostic method, and carrier means that detect and monitor occurrence of an abnormality in a machining state of a machine with high accuracy y in accordance with the type of the machining.

### Solution to Problem

In view of the foregoing, there is provided a diagnostic apparatus that includes a receiving unit to receive context information defining an operation of a tool attached to a spindle of a machine, rotation information of the spindle, tool information identifying the tool, and a detection result of a time-varying physical quantity that is generated by the tool executing a machining operation on a workpiece. The diagnostic apparatus further includes a frequency analysis unit to perform frequency analysis on the detection result, a range setting unit to set a frequency range, a bandwidth setting unit to set a bandwidth of a frequency band to be noted in the frequency range, and a band pass filter setting unit to set a band pass filter using a plurality of center frequencies and the bandwidth. The plurality of center frequencies is set using the rotation information, the tool information, and the frequency range. The diagnostic apparatus further includes a feature information extraction unit to extract feature information from the detection result using the band pass filter and a frequency analysis result of the detection result, and a determining unit to determine a machining state of the machine using the feature information.

Additionally, there is provided a machining system that includes the above-described diagnostic apparatus and the machine to be diagnosed by the diagnostic apparatus. The machine includes a transmitting unit to transmit the context information, the rotation information, the tool information, and the detection result to the diagnostic apparatus. Additionally, there is provided a method for diagnosing a machining state of a machine provided with a spindle to which a tool is attached. The method includes receiving context information defining an operation of the tool, rotation information of the spindle, tool information identifying the tool, and a detection result of a time-varying physical quantity that is generated by the tool executing a machining operation on a workpiece. The method further includes performing frequency analysis on the detection result, setting a frequency range; setting a bandwidth of a frequency band to be noted in the frequency range, setting a band pass filter using a plurality of center frequencies and the bandwidth, extracting feature information from the detection result using the band pass filter and a frequency analysis result of the detection result, and determining the machining state of the machine using the feature information. The plurality of center frequencies is set using the rotation information, the tool information, and the frequency range.

Additionally, there is provided carrier means carrying computer readable codes for controlling a computer to carry out the above-described method.

### Advantageous Effects of Invention

An aspect of the present disclosure provides an effects of detecting the occurrence of abnormality in a machining state of the machine in accordance with the type of the machining.

### BRIEF DESCRIPTION OF DRAWINGS

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

FIG. 1 is a block diagram illustrating an example of a configuration of a machining system including a diagnostic apparatus according to one embodiment of the present disclosure.

FIG. 2 is a block diagram illustrating a hardware configuration of a machine of the machining system illustrated in FIG. 1.

FIG. 3 is a block diagram illustrating a hardware configuration of the diagnostic apparatus of the machining system illustrated in FIG. 1.

FIG. 4 is a block diagram illustrating a hardware configuration of the diagnostic apparatus illustrated in FIG. 1.

FIG. 5 is a table illustrating an example of correspondence between context information and learned models stored in the diagnostic apparatus illustrated in FIG. 4.

FIG. 6 is a graph illustrating an example of average spectrum obtained by frequency analysis by a frequency analysis unit of the diagnostic apparatus according to one embodiment.

FIG. 7 is a graph illustrating another example of average spectrum obtained by frequency analysis by a frequency analysis unit of the diagnostic apparatus according to one embodiment.

FIG. 8 is a graph illustrating another example of average spectrum obtained by frequency analysis by the frequency analysis unit of the diagnostic apparatus according to one embodiment.

FIG. 9 is a graph illustrating another example of average spectrum obtained by frequency analysis by the frequency analysis unit of the diagnostic apparatus according to one embodiment.

FIG. 10 is a flowchart illustrating an example of an overall diagnostic operation performed by the diagnostic apparatus according to one embodiment.

FIG. 11 is a flowchart illustrating an example of model generation operation by the diagnostic apparatus according to one embodiment.

FIG. 12 is a flowchart illustrating an example of feature information extraction operation in accordance with band pass filter (BPF), performed by the diagnostic apparatus according to one embodiment.

FIG. 13 is a diagram illustrating an example of a method for selecting a BPF by the diagnostic apparatus according to one embodiment.

FIG. 14 is an enlarged view of the vicinity of the BPF of the average spectrum calculated by the diagnostic apparatus according to one embodiment.

FIG. 15 is a graph illustrating an example of the average spectrum obtained by frequency analysis by the diagnostic apparatus according to one embodiment.

FIG. 16 is a flowchart illustrating another example of the feature information extraction operation in accordance with the BPF, performed by the diagnostic apparatus according to one embodiment.

FIG. 17 is a graph illustrating an example of autocorrelation function obtained by the diagnostic apparatus according to one embodiment.

### DESCRIPTION OF EMBODIMENTS

The terminology used herein is for the purpose of describing particular embodiments only and is not intended to be limiting of the present invention. As used herein, the singular forms “a,” “an,” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Descriptions are given below in detail of embodiments of a diagnostic apparatus, a diagnostic method, a recording medium storing program codes for the diagnostic method, and a machining system according to the present disclosure, with reference to the drawings.

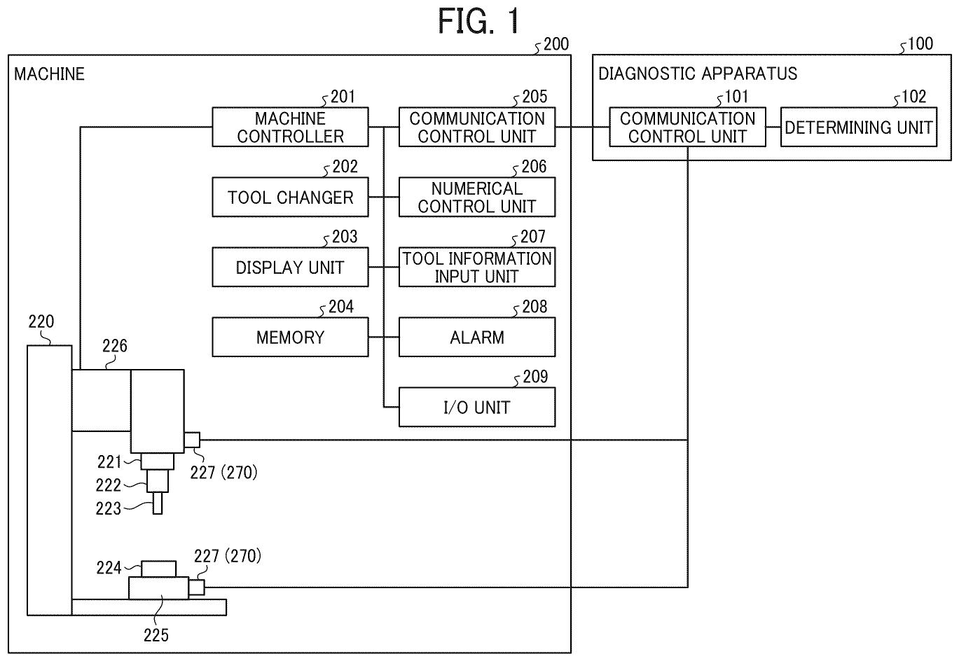

FIG. 1 is a block diagram illustrating an example of a configuration of a machining system including a diagnostic apparatus according to the present embodiment. As illustrated in FIG. 1, the machining system according to the present embodiment includes a machine 200 and a diagnostic apparatus 100.

The machine 200 and the diagnostic apparatus 100 may be connected in any connection form. For example, the machine 200 and the diagnostic apparatus 100 are connected by a dedicated connection line, a wired network such as a wired local area network (LAN), or a wireless network.

The diagnostic apparatus 100 includes a communication control unit 101 and a determining unit 102. The machine 200 includes a machine controller 201, a tool changer 202, a display unit 203, a memory 204, a communication control unit 205, a numerical control unit 206, a tool information input unit 207, an alarm 208, an input/output (I/O) unit 209, a machine tool 220, and the like.

The machine tool 220 has a Z-axis stage 226 that moves in the vertical direction in FIG. 1 and includes a driver such as a motor. The Z-axis stage 226 includes a spindle 221 which is an example of a rotation shaft of the machine 200. On the spindle 221, a tool holder 222 that holds a tool 223 is mounted. The machine tool 220 includes an XY-axes stage 225 which moves in biaxial directions in a plane perpendicular to the Z-axis stage 226. The XY-axes stage 225 is disposed below the spindle 221 and includes a driver such as a motor. The XY-axes stage 225 holds a workpiece 224 (an object to be machined).

The numerical control unit 206 controls machining by the machine 200 by numerical control. For example, the numerical control unit 206 reads a machining program from the I/O unit 209, and generates and outputs numerical control data for controlling spindle rotation and the position of each axis stage. In the machining program, the storage number of the tool changer 202 is described, and the numerical control unit 206 performs tool change according to the description.

The numerical control unit 206 outputs context information to the communication control unit 205. The context information is information that defines the operation of the tool 223 of the machine 200. The context information includes a plurality of information defined for each operation type of the tool 223. In the present embodiment, the context information includes, for example, tool information identifying the tool 223, rotation information of the spindle 221, such as the rotation speed of the spindle 221 (also referred to as “spindle rotation speed”), and movement information (e.g., movement speed and in-movement information) of the Z-axis stage 226 and the XY-axes stage 225.

The tool information includes at least information indicating a tool type such as a drill, a reamer, or an end mill; and tool information such as the number of cutting edges. The tool information is input by an operator from the tool information input unit 207 in accordance with the information displayed on the display unit 203. Alternatively, the tool information can be obtained by reading a list file of the tool information from the I/O unit 209 or inputting information from an external computer via the communication control unit 205. The tool information may be stored in the memory 204 so as to be referred to by the machining program.

The numerical control unit 206 transmits, for example, context information defining the current operation of the tool 223 to the diagnostic apparatus 100 via the communication control unit 205. When machining the workpiece 224 according to the machining program, the numerical control unit 206 controls the type of the tool 223, the positions of the Z-axis stage 226 and the XY-axes stage 225, the rotation speed of the spindle 221, and the like corresponding to the machining process. The numerical control unit 206 transmits context information corresponding to a specific operation among the context information to the diagnostic apparatus 100 via the communication control unit 205. Among operations of the tool 223, the specific operation is prescribed by the machining program. In the present embodiment, every time the type of operation of the tool 233 is changed, the numerical control unit 206 sequentially transmits context information corresponding to the changed type of operation to the diagnostic apparatus 100 via the communication control unit 205.

The communication control unit 205 (an example of a transmitting unit) controls communication with an external device such as the diagnostic apparatus 100. For example, the communication control unit 205 transmits context information corresponding to the current operation of the tool 223 to the diagnostic apparatus 100.

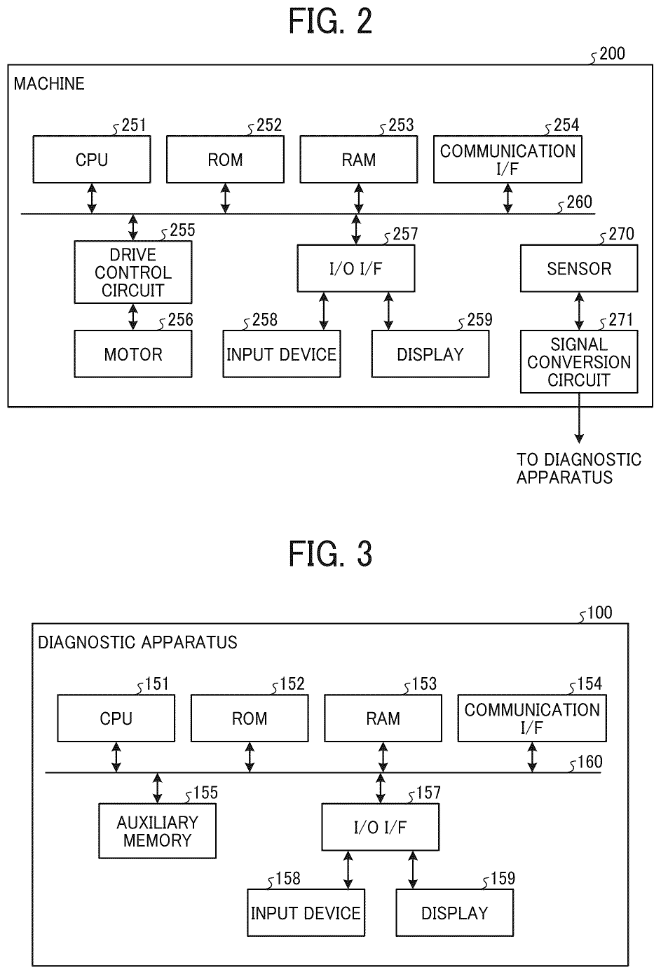

The machine 200 further includes a physical quantity information detector 227 that includes sensors 270 to detects, as an analog signal, a time-varying physical quantity generated by the tool 223 during execution of a machining operation on the workpiece 224. The physical quantity information detector 227 includes a signal conversion circuit 271 (illustrated in FIG. 2) that amplifies, as appropriate, an analog signal detected by the sensor 270, cuts a freely selected frequency range, and then converts the analog signal into a digital signal. The physical quantity information detector 227 also functions as an example of a transmitting unit that transmits the digital signal to the diagnostic apparatus 100 as a detection result. The type of the sensors 270 of the physical quantity information detector 227 and the type of the physical quantity to be detected are not limited. For example, the sensor 270 of the physical quantity information detector 227 is a microphone, an accelerometer, or an acoustic emission (AE) sensor, and outputs acoustic data, acceleration data, or data indicating an AE wave as a detection result. In addition, the number of the physical quantity information detectors 227 included in the diagnostic apparatus 100 is not limited. The diagnostic apparatus 100 may include a plurality of physical quantity information detectors 227. For example, the diagnostic apparatus 100 may include a plurality of sensors 270 that detect different types of physical quantities.

In FIG. 1, the physical quantity information detector 227 includes the sensor 270 mounted on a side face of a structure that holds the spindle 221 and the sensor 270 mounted on a side face of the XY-axes stage 225. The sensor 270 of the physical quantity information detector 227 incorporates an accelerometer. When the machine 200 starts machining, the physical quantity information detector 227 detects the acceleration of the vibration generated by the rotation of the spindle 221. In the machine 200, when the tool 223 contacts the workpiece 224 to start actual cutting, a cutting force is generated. The cutting force serves as an excitation force to vibrate the tool 223 and the workpiece 224, and the vibrations propagate to each other. The physical quantity information detector 227 transmits the acceleration or the like of the vibration to the diagnostic apparatus 100 as a detection result.

In the machine 200, the cutting forces of the cutting edges are uniform during normal machining. For example, when the cutting edge of the tool 223 is broken or chipped during machining, the cutting forces of the cutting edges are uneven, causing a change in the generated vibrations. Alternatively, in the machine 200, when chips are sandwiched between the tool holder 222 and the spindle 221 at the time of replacement of the tool 223, whirling (runout) of the cutting edge at the tip of the tool 223 with respect to the rotation axis increases. As a result, the cutting amount per cutting edge of the tool 223 becomes uneven, and the uneven cutting force causes a vibration change similar to the case where the cutting edge is damaged.

The diagnostic apparatus 100 receives, with the communication control unit 101, the result of detection on the vibration. The communication control unit 101 controls communication with the machine 200 and further receives the context information from the machine 200. The determining unit 102 refers to the context information and the detection result, and determines whether or not the machining state of the machine 200 is normal. In response to determining that the machining state of the machine 200 is abnormal, the diagnostic apparatus 100 transmits alert information to the machine 200 via the communication control unit 101. In response to receiving, with the communication control unit 205, of the alert information, the machine 200 displays the alert information on the display unit 203 or activates the alarm 208. The alarm 208 is, for example, a patrol lamp, a buzzer, or a speaker. In addition, the machine controller 201 interrupts the operation of the machine 200 according to the machining program, so as to stop the machining of the machine 200.

FIG. 2 is a block diagram illustrating a hardware configuration of the machine according to the present embodiment. As illustrated in FIG. 2, the machine 200 according to the present embodiment includes a central processing unit (CPU) 251, a read only memory (ROM) 252, a random access memory (RAM) 253, a communication interface (I/F) 254, a drive control circuit 255, a motor 256, an input/output (I/O) I/F 257, an input device 258, and a display 259, which are connected via a bus 260.

The CPU 251 controls the entire operation of the machine 200. The CPU 251 executes a program stored in the ROM 252 or the like using, for example, the RAM 253 as a work area, to control the entire operation of the machine 200 and implement various functions of the machine 200.

The communication I/F 254 is an interface for communicating with external devices such as the diagnostic apparatus 100. The drive control circuit 255 is a circuit that controls the drive of the motor 256. Each of the spindle 221, the Z-axis stage 226, and the XY-axes stage 225 includes a driver such as the motor 256. The sensor 270 is attached to the machine 200 and converts, into an electrical signal, a physical quantity that changes in accordance with the operation of the machine 200. The signal conversion circuit 271 amplifies the electric signal output from the sensor 270 to a desired magnitude, cuts a noise component included in the electric signal, and converts the electric signal into a digital signal. Then, the signal conversion circuit 271 outputs the digital signal to the diagnostic apparatus 100 as a detection result. That is, the sensor 270 and the signal conversion circuit 271 correspond to, for example, the physical quantity information detector 227 illustrated in FIG. 1.

The numerical control unit 206 and the communication control unit 205 illustrated in FIG. 1 may be implemented by the CPU 251 executing a program stored in by the ROM 252, that is, by software. Alternatively, the numerical control unit 206 and the communication control unit 205 may be implemented by hardware such as an integrated circuit (IC), or may be implemented by a combination of software and hardware.

FIG. 3 is a block diagram illustrating a hardware configuration of the diagnostic apparatus according to the present embodiment. As illustrated in FIG. 3, the diagnostic apparatus 100 according to the present embodiment includes a CPU 151, a ROM 152, a RAM 153, a communication I/F 154, an auxiliary memory 155, and an I/O I/F 157, which are connected via a bus 160.

The CPU 151 controls the entire operation of the diagnostic apparatus 100. The CPU 151 executes a program stored in the ROM 152 or the like using, for example, the RAM 153 as a work area, to control the entire operation of the diagnostic apparatus 100 and implement various diagnostic functions of the machine 200.

The communication I/F 154 is an interface for communicating with external devices such as the machine 200. The auxiliary memory 155 stores various information such as setting information of the diagnostic apparatus 100, the context information received from the machine 200, and the detection result output from the physical quantity information detector 227. The auxiliary memory 155 stores various calculation results used for determining whether the machining state of the machine 200 is normal. The auxiliary memory 155 includes a nonvolatile memory such as a hard disk drive (HDD), an electrically erasable programmable read-only memory (EEPROM), or a solid state drive (SSD).

The I/O I/F 157 sequentially displays, on a display 159, the detection result input from the physical quantity information detector 227 or the determination result by the determining unit 102. The I/O I/F 157 receives settings for diagnosis of the machine 200. The user inputs such settings via an input device 158, such as a keyboard or a mouse, while viewing the display 159.

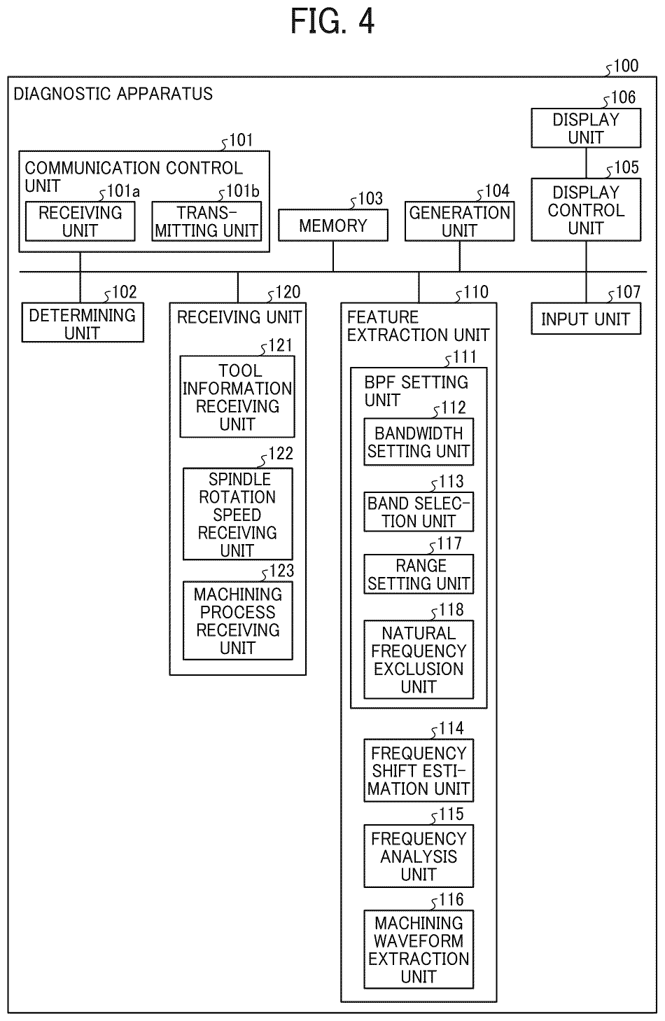

FIG. 4 is a block diagram illustrating an example of a functional configuration of the diagnostic apparatus according to the present embodiment. In addition to the above-described communication control unit 101 and the determining unit 102, the diagnostic apparatus 100 according to the present embodiment includes a memory 103, a generation unit 104, a display control unit 105, a display unit 106, an input unit 107, a receiving unit 120, and a feature extraction unit 110.

The memory 103 stores various kinds of information used for the diagnostic function of the diagnostic apparatus 100. The memory 103 is implemented by any desired memory, for example, the RAM 153 and the auxiliary memory 155 illustrated in FIG. 3. For example, the memory 103 stores one or more models (hereinafter may be referred to as learned models) used for determination of abnormality in the machining state of the machine 200. The learned model is generated by learning of the detection result output from the physical quantity information detector 227, for example, when the machining state of the machine 200 is normal. The learning method of the learned model and the format of the learned model may be any method and any format. For example, a learned model such as a Gaussian mixture model (GMM) or a hidden Markov model (HMM) and a model learning method corresponding to such a learned model can be applied to the present embodiment.

In addition, the memory 103 may store rules of a normal machining state or an abnormal machining state of the machine 200 as a learned model. For example, the rule stored in the memory 103 as the learned model specifies that the first ten times of machining started after attachment of a new tool 223 is a learning period for determining a rule for diagnosis. The rule stored as the learned model in the memory 103 may be determined in advance separately from actual machining, and the determined rule may be stored as the learned model in the memory 103.

In the present embodiment, the learned model stored in the memory 103 is generated for each context information. The memory 103 stores, for example, the context information and a learned model corresponding to the context information in association with each other.

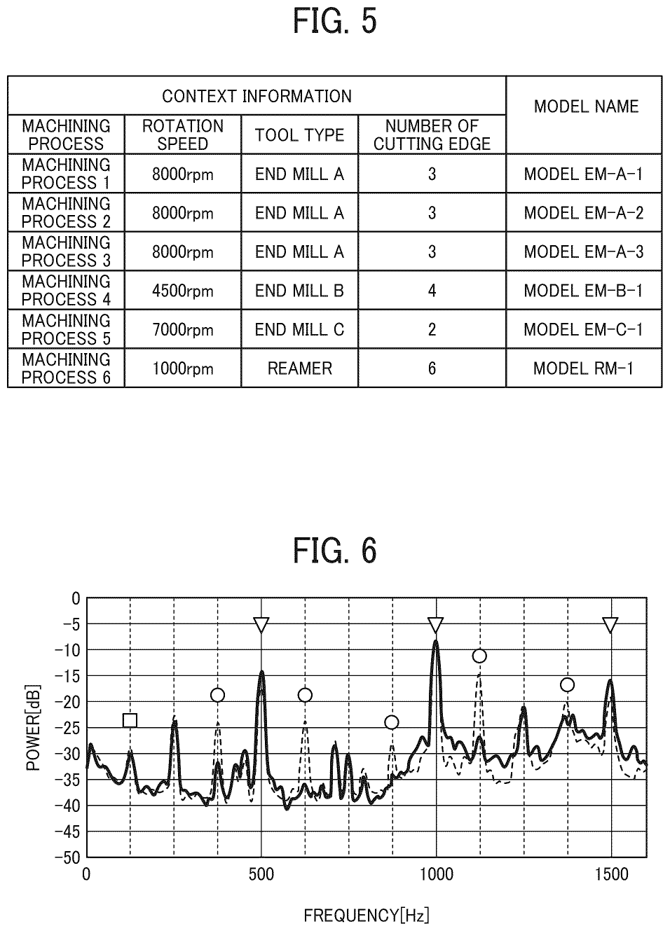

FIG. 5 is a table illustrating an example of correspondence between the context information and learned models stored in the diagnostic apparatus according to the present embodiment. As illustrated in FIG. 5, in machining processes 1, 2, and 3, the same end mill A is used, and the rotation speed is the same. On the other hand, in machining processes 4, 5, and 6, different tools 223 are used, and the tools 223 are rotated at different rotation speeds. In the present embodiment, the diagnostic apparatus 100 generates a learned model for each of different rotation speeds and different types of tools 223, and stores the learned models in the memory 103.

Further, the machining processes 1, 2, and 3 are consecutive machining processes on the same portion using the same end mill A. However, in the machining processes 1, 2, and 3, the machining conditions are different from each other, and the vibration intensities are also different from each other. Therefore, even when machining is performed by rotating the same tool 223 at the same rotation speed, the diagnostic apparatus 100 generates a different learned model for each machining process and determines whether or not the machining state of the machine 200 is normal.

Returning back to FIG. 4, the communication control unit 101 includes a receiving unit 101a and a transmitting unit 101b. The receiving unit 101a receives various kinds of information transmitted from the machine 200 or an external apparatus. For example, the receiving unit 101a receives the context information corresponding to the current operation of the tool 233 and the detection result output from the physical quantity information detector 227. The transmitting unit 101b transmits various kinds of information to the machine 200.

The feature extraction unit 110 generates a learned model and extracts feature information (feature value) used for determination by the determining unit 102 from the detection result. The feature information may be any information indicating a feature of the detection result. For example, when the detection result is acoustic data collected by a microphone, the feature extraction unit 110 extracts a feature value such as energy, a frequency spectrum, or mel-frequency cepstrum coefficients (MFCC) from the detection result. In the present embodiment, the feature extraction unit 110 includes a band pass filter (BPF) setting unit 111, a frequency shift estimation unit 114, a frequency analysis unit 115, and a machining waveform extraction unit 116. Furthermore, the BPF setting unit 111 includes a bandwidth setting unit 112, a band selection unit 113, a range setting unit 117, and a natural frequency exclusion unit 118.

The generation unit 104 generates a learned model for determining the normal machining state of the machine 200 by learning of the feature information extracted from the detection result in the normal machining state of the machine 200. However, when the learned model is generated by an external device, the diagnostic apparatus 100 may not include the generation unit 104. To be specific, in another embodiment, an external device generates the learned model, and the learned model generated by the external device is received by the receiving unit 101a and stored in the memory 103. When context information for which a learned model is not defined and detection result corresponding to the context information are input, the generation unit 104 may generate a learned model corresponding to the context information using feature information extracted from the detection result.

The determining unit 102 determines the machining state of the machine 200 using the feature information extracted from the detection result. In the present embodiment, the determining unit 102 determines the machining state of the machine 200 using the feature information and the learned model corresponding to the context information. For example, the determining unit 102 requests the feature extraction unit 110 to extract feature information from the detection result. The determining unit 102 calculates a likelihood that the feature information extracted from the detection result is normal, using the corresponding learned model. The determining unit 102 compares the likelihood with a threshold value. When the likelihood is equal to or greater than the threshold, the determining unit 102 determines that the machining state of the machine 200 is normal. When the likelihood is less than the threshold value, the determining unit 102 determines that the machining state of the machine 200 is abnormal.

The method for determining the machining state of the machine 200 is not limited thereto. The determining unit 102 may use any method that can determine the machining state of the machine 200 using the feature information and the model. For example, instead of directly comparing the likelihood with the threshold value, the determining unit 102 may compare a value indicating a change in the likelihood with a threshold value, thereby determining whether or not the machining state of the machine 200 is normal. Alternatively, the determining unit 102 calculates a score that is a positive numerical value equal to or greater than 0, obtained by taking the logarithm of the likelihood and inverting the sign. Such a score is close to 0 when the machining state of the machine 200 is normal. The score increases as the degree of abnormality of the machining state of the machine 200 increases. Therefore, the determining unit 102 determines that the machining state of the machine 200 is normal when the score is not equal to or smaller than (or smaller than) a threshold. The determining unit 102 determines that the machining state of the machine 200 is abnormal when the score is greater than (or equal to or greater than) the threshold value. That is, the determining unit 102 determines the machining state of the machine 200 by comparing, with the threshold value, one of the likelihood and a value calculated using the likelihood; or by comparing, with the threshold values, both of the likelihood and the value calculated using the likelihood.

Each unit (the communication control unit 101, the determining unit 102, the receiving unit 120, the feature extraction unit 110, and the generation unit 104) illustrated in FIG. 4 may be implemented by the CPU 151 illustrated in FIG. 3 executing a program, that is, by software. These units may be implemented by hardware such as an IC or by a combination of software and hardware.

The diagnostic apparatus 100 according to the present embodiment is characterized in the feature extraction unit 110 and the receiving unit 120. As described above, the feature extraction unit 110 includes the BPF setting unit 111, the frequency shift estimation unit 114, the frequency analysis unit 115, and the machining waveform extraction unit 116. As described above, the BPF setting unit 111 includes the bandwidth setting unit 112, the band selection unit 113, the range setting unit 117, and the natural frequency exclusion unit 118. In addition, in the present embodiment, the diagnostic apparatus 100 uses context information such as the spindle rotation speed and tool information during operation of the machine 200 or before or after the operation. Therefore, the receiving unit 120 includes a tool information receiving unit 121, a spindle rotation speed receiving unit 122, and a machining process receiving unit 123.

Next, the operation of the diagnostic apparatus 100 according to the present embodiment will be described in detail with reference to FIG. 4.

In the present embodiment, in the machine 200, the physical quantity information detector 227 is disposed near the spindle 221, and the physical quantity information detector 227 includes an accelerometer as the sensor 270. The physical quantity information detector 227 amplifies an analog signal detected by the sensor 270 by a preamplifier of the sensor 270. The physical quantity information detector 227 performs sampling at set time intervals, and converts the sampled analog signal into a digital signal with an analog/digital (A/D) converter (the signal conversion circuit 271). The diagnostic apparatus 100 receives, with the receiving unit 101a, the digital signal output from the physical quantity information detector 227 as a detection result. The digital signal output from the physical quantity information detector 227 may be converted in a unit of acceleration by the calibration value of the sensor 270 as desired. In this specification, a description of such processing is omitted, and the digital signal is described as being independent of the sensitivity of the sensor 270 or the specification of the A/D converter (signal conversion circuit 271). Therefore, the receiving unit 101a receives, as the detection result, the waveform in the time domain of the observed value proportional to the acceleration detected by the sensor 270 of the physical quantity information detector 227.

In one example, the machine 200 forms a rough hole having a depth of 5.0 mm in an aluminum alloy plate with a drill having a radius of 8.2 mm, and then performs contouring by rotating a four-edge end mill having a radius of 8.0 mm at 7500 rpm. The contouring is divided into three steps, and the cutting depth in the radial direction of the tool 223 is set to 100.0 micrometer, 200.0 micrometer, and 32.0 micrometer, respectively. The XY-axes stage 225 performs the rotation so as to widen the diameter of the rough hole at this cutting depth. At this time, the machine 200 rotates the XY-axes stage 225 at 90.0 mm/min in the same direction as the rotation direction of the spindle 221.

The receiving unit 120 of the diagnostic apparatus 100 requests the machine 200 to transmit the context information from each of the spindle rotation speed receiving unit 122, the tool information receiving unit 121, and the machining process receiving unit 123. The context information is transmitted and received via the communication control unit 205 and the communication control unit 101. The context information mentioned here includes rotation information, machining process information, and tool information.

The rotation information may be either the spindle rotation speed set from the machining program read by the machine 200 or the spindle rotation speed measured by a tachometer in the machine 200. The rotation information is, for example, revolutions per minute (e.g., 7500 rpm) set from the machining program. The machining process information includes a number identifying the machining process described in the machining program, and information about start and end of the operation of the spindle 221 and the stages (the XY-axes stage 225 and the Z-axis stage 226). The machining process information is, for example, information on start and end of the rotation of the XY-axes stage 225. The tool information includes the tool type, the diameter, and the number of edges. However, the tool information is not limited to the context information from the machine 200. The context information may be context information input from the input device 158 to the diagnostic apparatus 100, context information stored in the auxiliary memory 155, or context information received from an external device other than the machine 200 through the receiving unit 101a. The tool information is, for example, the number of edges (for example, four) of the tool 223.

The machining waveform extraction unit 116 of the feature extraction unit 110 extracts, from the detection result, such as waveform data of acceleration (acceleration waveform data) input from the physical quantity information detector 227. Specifically, the machining waveform extraction unit 116 extracts waveform data during machining (hereinafter may be referred to as “in-machining waveform data”), for each cutting depth of the tool 223, in time sections respectively corresponding to three machining times of rotation of the XY-axes stage 225, start of rotation thereof, and end of rotation thereof. The frequency analysis unit 115 performs frequency analysis on the detection result. The frequency analysis unit 115 performs a Fourier transform, for example, using a fast Fourier transform (FFT) algorithm, on a predetermined number of samples among the extracted in-machining waveform data. The predetermined number may be empirically obtained and stored in a memory. The entire data string of the in-machining waveform data to be subjected to the Fourier transform may be constructed from the extracted in-machining waveform data, or a part of the data string may be replaced with 0. However, the machining waveform extraction unit 116 determines frequency resolution which can be analyzed by Fourier transform based on the time interval of sampling of the detection result (acceleration waveform data) before the A/D conversion by the signal conversion circuit 271 and the data length (the number of data of data string) of the detection result. The present embodiment is described on the assumption that the combination of the time interval and the data length is set so that the frequency resolution is about 5.8 Hz.

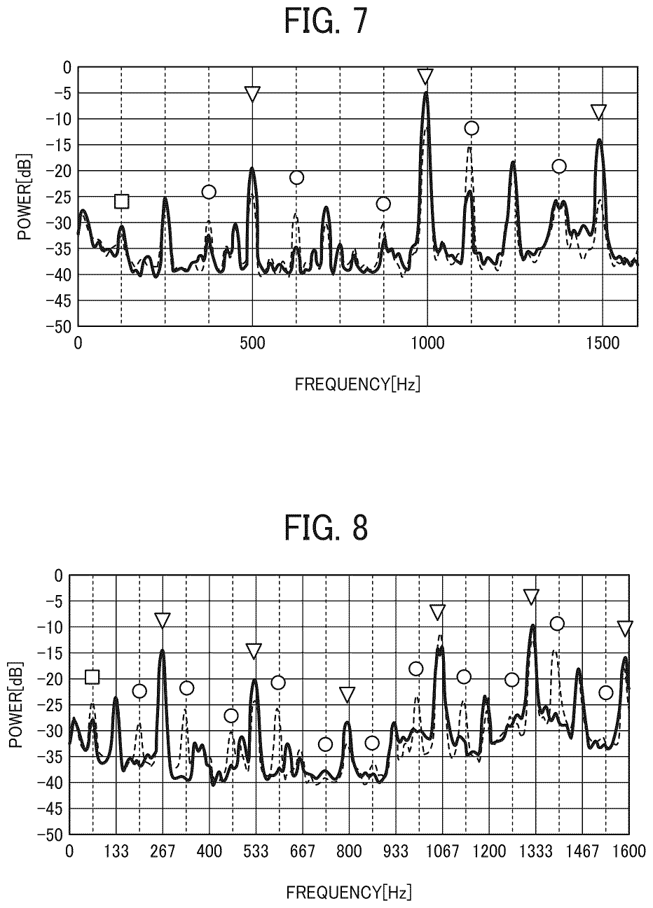

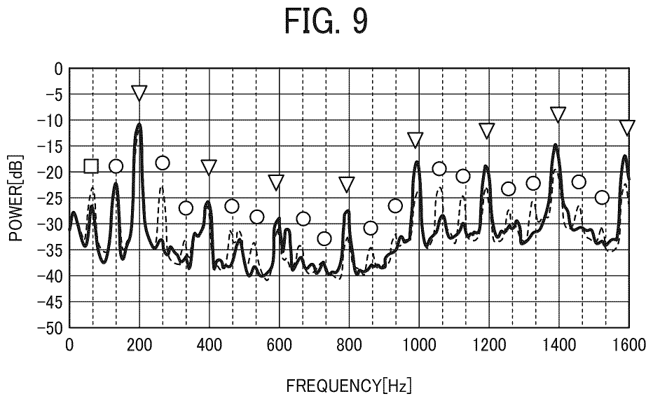

FIGS. 6 to 9 are graphs illustrating examples of average spectra obtained by frequency analysis by the frequency analysis unit of the diagnostic apparatus according to the present embodiment. The average spectra illustrated in FIGS. 6 to 9 ware obtained by extracting a data string shifted by a desired time from the beginning of the in-machining waveform data, performing Fourier transform on the data string to obtain power of amplitude, and averaging the power. The average spectrum illustrated in FIG. 6 was obtained when the cutting depth of the tool 223 was 200.0 μm. The average spectrum illustrated in FIG. 7 was obtained when the cutting depth of the tool 223 was 32.0 μm. The average spectrum illustrated in FIG. 8 was obtained when the rotation speed of the spindle 221 was changed. The average spectrum illustrated in FIG. 9 was obtained when the tool 223 was changed. In FIGS. 6 to 9, the average spectrums of the frequency equal to or smaller than 1600.0 Hz are illustrated. In In FIGS. 6 and 7, a solid line represents an average spectrum obtained by measuring the runout of the cutting edge of the tool 223 with a dial gauge, and adjusting the maximum and minimum runout widths thereof to 2.0 μm. In FIGS. 6 and 7, the dotted line represents the average spectrum obtained by adjusting the runout of the cutting edge of the tool 223 from about 15.0 μm to about 20.0 μm.

When the rotation speed of the spindle 221 is 7500 rpm, the speed of 7500 rpm is converted into a frequency of 125.0 Hz. Further, since the number of edges of the end mill which is an example of the tool 223 is four, in the machine 200, intermittent cutting at 500.0 Hz (calculated by multiplying 125.0 Hz with 4 edges) is repeated. Then, cutting force is generated, and vibration is generated and propagated to the machine 200 and the workpiece 224. Accordingly, to the diagnostic apparatus 100, the corresponding acceleration waveform data is input as a detection result. The frequency of the acceleration waveform data is referred to as a tool passing frequency (TPF). Therefore, the average spectrum obtained by the frequency analysis unit 115 ideally has a spectrum structure having sharp peaks at a TPF and a plurality of harmonic components thereof.

The solid line illustrated in FIGS. 6 and 7 is an average spectrum in which the edge runout of the tool 223 is restricted to 2.0 μm or less. In addition, peaks indicated by inverted triangles in the average spectrum indicate the TPF, the second harmonic of the TPF, and the third harmonic of the TPF, that is, indicate large power. In reality, however, the edge runout of the tool 223 is not reduced to 0, so other peaks are observed. On the other hand, the dotted line illustrated in FIGS. 6 and 7 represents an average spectrum (large runout) in which the runout of the edge of the tool 223 is adjusted to a range from 15.0 μm to 20.0 μm. In the average spectra illustrated in FIGS. 6 and 7, increases in the power at peaks other than TPF and harmonic components of TPF are observed. In the spectra illustrated in FIGS. 6 and 7, the peaks indicated by a square mark is 125.0 Hz corresponding to the rotation speed of the spindle 221, and this frequency is referred to as a fundamental rotation frequency. The peaks indicated by circles in the average spectra illustrated in FIGS. 6 and 7 are components increased or decreased by the fundamental rotation frequency from the TPF and the harmonic components thereof, that is, modulated components referred to as sideband waves. When the waveform of the TPF component is viewed in time series, the amplitude of the waveform becomes uneven due to the runout of the cutting edge, appearing as a spectral feature. In addition, when the cutting edge is damaged, the cutting force becomes uneven, and the generated vibration also becomes uneven in the same manner as the runout of the cutting edge. Then, a similar increase in the sideband wave is observed. As described above, as compared with the sideband wave in the normal machining state of the machine 200, the sideband wave in the abnormal machining state increases, and exhibits a positive correlation. On the other hand, when attention is focused on the TPF and the harmonic components thereof, it is observed that the power of the average spectrum decreases as the runout of the cutting edge increases. Therefore, the power of the average spectrum of the TPF and harmonic components thereof exhibit a negative correlation when the machining state changes from normal to abnormal.

Such characteristics are observed even when the rotation speed of the spindle 221 or the number of edges of the tool 223 is changed. The average spectrum illustrated in FIG. 8 was obtained in a machining process in which the same four-edge end mill was used, the rotation speed of the spindle 221 was set to 4000 rpm, and the cutting depth was set to 200.0 μm. The average spectrum illustrated in FIG. 9 was obtained in a machining process in which a three-edge end mill having a diameter of 8.0 mm was used, the rotation speed of the spindle 221 was set to 4000 rpm, and the cutting depth was set to 200.0 μm. In both average spectra illustrated in FIG. 8 and FIG. 9, the above-described features are observed for most of the TPFs, the harmonic components thereof, and the respective sidebands. Further, at the fundamental rotation frequency of the average spectrum illustrated in FIGS. 8 and 9, the power increases as the runout of the cutting edge increases. This is a part of the component generated by the runout due to the chuck error caused by a chip entered between the spindle 221 and the tapered portion of the tool holder as described above.

In the average spectra illustrated in FIGS. 6 and 7, since the cutting depth of the tool 223 is different, the shape of the envelope of the entire average spectrum and the power at the same frequency are also different. Accordingly, it is desirable to use different models for different machining processes even when the same tool 223 is rotated at the same rotation speed. As illustrated in FIG. 5, generating the learned model based on the context information for each machining process is useful.

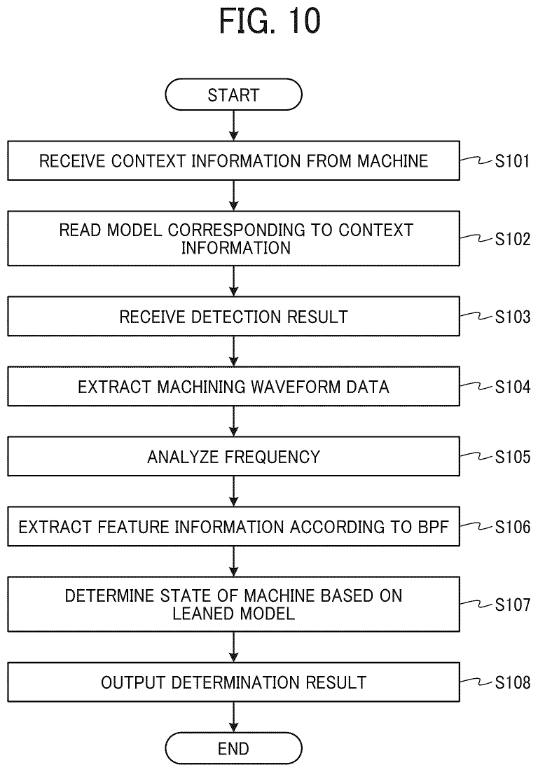

FIG. 10 is a flowchart illustrating an example of an overall diagnostic operation performed by the diagnostic apparatus according to the present embodiment. The numerical control unit 206 of the machine 200 sequentially transmits context information indicating the current operation of the tool 223 to the diagnostic apparatus 100. The receiving unit 101a receives the context information transmitted from the machine 200 (step S101). In S102, the feature extraction unit 110 reads the learned model corresponding to the received context information from the memory 103. The step S102 may be performed at any timing, such as immediately before the step S106, before the feature information according to the BPF described later is extracted in step S106.

The physical quantity information detector 227 of the machine 200 sequentially outputs detection results during machining operation of the machine 200. The receiving unit 101a receives the detection result (sensor data) transmitted from the machine 200 (step S103). The machining waveform extraction unit 116 of the feature extraction unit 110 extracts in-machining waveform data from the received detection result and the context information defining the machining operation (step S104). In step S105, the frequency analysis unit 115 performs frequency analysis of the in-machining waveform data using an FFT algorithm or the like. The frequency analysis is performed on the set number of data samples in the in-machining waveform data while shifting the start position of the data string. The number of data samples may be empirically obtained by the manufacturer or the operator of the diagnostic apparatus 100 and stored in a memory. The frequency analysis on the in-machining waveform data generates, as a result, data having a three dimensional structure in which plural spectra are arranged in time series. The feature extraction unit 110 extracts feature information from an average spectrum obtained by averaging the plural spectra or by averaging the plural spectra in a desired time range (step S106). In the present embodiment, since the BPF is recorded in the learned model read in step S102, the feature extraction unit 110 extracts feature information from the average spectrum using the BPF.

The determining unit 102 determines the machining state of the machine 200 using the feature information extracted by the feature extraction unit 110 and the learned model corresponding to the received context information (step S107). Accordingly, the diagnostic apparatus 100 determines the machining state of the machine 200 using the feature information and the learned model extracted according to the tool 223 or the type of machining. This enables detection and monitoring of the occurrence of an abnormality in the machining state of the machine 200 with high accuracy for various types of machining performed in the machining center. The determining unit 102 outputs the determination result to the display unit 106 via the display control unit 105 (step S108). Alternatively, the determining unit 102 transmits the alert information to the machine 200 or an external apparatus via the transmitting unit 101b (step S108).

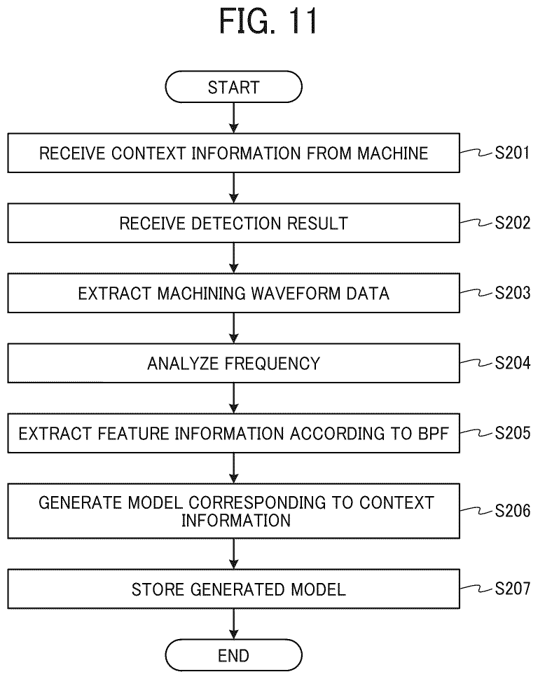

Next, an example of model generation operation by the diagnostic apparatus 100 according to the present embodiment will be described with reference to FIG. 11. FIG. 11 is a flowchart illustrating an example of the sequence of the model generation operation by the diagnostic apparatus according to the present embodiment. In the present embodiment, for example, the generation unit 104 executes model generation operation before diagnostic operation of the machine 200. Alternatively, as described above, the generation unit 104 may execute the model generation operation in response to input of the context information for which a learned model is not defined. Alternatively, as described above, the learned model may be generated by an external device not by the diagnostic apparatus 100.

The receiving unit 101a receives the context information transmitted from the machine 200 (step S201). The receiving unit 101a receives the detection result (sensor data) transmitted from the machine 200 (step S202).

The context information and the detection result received in this manner are used to generate a learned model. In the present embodiment, since the generation unit 104 generates the learned model for each context information, the detection result is to be associated with the corresponding context information. Therefore, for example, the receiving unit 101a temporarily stores the received detection result in the memory 103 or the like in association with the context information received at the same time or corresponding time. Then, the generation unit 104 confirms that the detection result stored in the memory 103 is information at the normal time, and generates the learned model using only the detection result at the normal time. That is, the generation unit 104 generates the learned model using the detection result labeled as normal.

The confirmation (labeling) of whether or not the detection result is normal may be performed at any timing after the detection result is stored in the memory 103 or the like, or may be performed in real time while the machine 200 is operated. Alternatively, without labeling the detection result, the generation unit 104 may generate the learned model on the assumption that the detection result is normal. In the case where the detection result assumed to be normal is actually an abnormal detection result, whether the machining state of the machine 200 is normal is not correctly determined by the generated learned model. Therefore, whether the learned model is generated using the abnormal detection result can be determined based on, for example, the frequency of determining that the machining state of the machine 200 is abnormal. Then, the learned model erroneously generated is deleted, for example.

Alternatively, a learned model generated by using abnormal detection results may be used as a learned model for determining abnormality.

The machining waveform extraction unit 116 of the feature extraction unit 110 extracts the in-machining waveform data based on the received detection result and the context information during the machining operation (step S203). In step S204, the frequency analysis unit 115 performs frequency analysis of the extracted in-machining waveform data using an FFT algorithm or the like. The frequency analysis unit 115 performs frequency analysis on the preset number of data samples in the in-machining waveform data while shifting the start position of the data string. The obtained frequency analysis result is data of a three dimensional structure in which plural spectra are arranged in time series. The feature extraction unit 110 extracts feature information from an average spectrum obtained by averaging the plural spectra or by averaging plural spectra in a desired time range according to the BPF (step S205). This method will be described in detail later.

The generation unit 104 generates a learned model corresponding to the context information by using the feature information extracted from the detection result associated with the same context information (step S206). The generation unit 104 stores the generated learned model in the memory 103 (step S207).

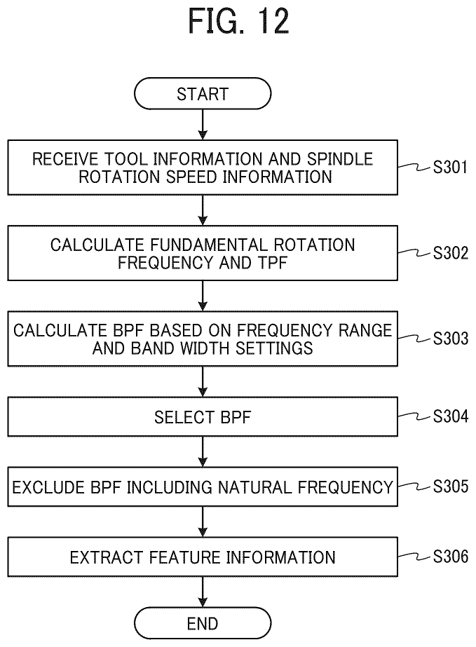

Next, referring to FIG. 12, a description is given of an example of a sequence of operation by the feature extraction unit 110 of extracting the feature information in accordance with the BPF according to the present embodiment. FIG. 12 is a flowchart illustrating an example of a sequence of the feature information extraction operation in accordance with the BPF, performed by the diagnostic apparatus according to the present embodiment.

The BPF setting unit 111 receives tool information such as a number t of cutting edges and rotation information such as a spindle rotation speed r from the tool information receiving unit 121 and the spindle rotation speed receiving unit 122 of the receiving unit 120 (step S301). Then, the BPF setting unit 111 calculates the fundamental rotation frequencies and the TPF by using Equations 1 and 2 (step S302). The spindle rotation speed r is the number of revolutions per minute of the spindle 221 set by the machining program.

Fundamental rotation frequency [Hz]=r[rpm]/60 Equation 1

TPF=fundamental rotation frequency [Hz]×t Equation 2

where r represents the spindle rotation speed, and t represents number of cutting edges. That is, the BPF setting unit 111 calculates the fundamental rotation frequency using the rotation information, and calculates the TPF using the fundamental rotation frequency and the number of edges included in the tool information.

Next, the BPF setting unit 111 of the feature extraction unit 110 sets (calculates) a BPF center frequency (an example of a center frequency) using the rotation information, the tool information, and a frequency range. In the present embodiment, the BPF setting unit 111 sets the BPF center frequency in the frequency range set by the range setting unit 117 of the BPF setting unit 111 using Equation 3. The range setting unit 117 sets a frequency range to be noted. The range setting unit 117 sets, for example, a lower limit frequency and an upper limit frequency, and calculates a natural number n such that the BPF center frequency of Equation 3 falls in this range. Alternatively, the natural number n may be any number, such as the order of harmonics of the fundamental rotation frequency [Hz] or the order of harmonics of the TPF, as long as the lower limit and the upper limit of the frequency can be specified. That is, the BPF setting unit 111 sets, as the BPF center frequencies, the fundamental rotation frequency and a frequency that is an integral multiple of the fundamental rotation frequency. Alternatively, the BPF setting unit 111 may set, as the BPF center frequencies, the TPF and the sideband wave of each integral multiple of the TPF.

Further, the BPF setting unit 111 calculates the BPFs from the BPF center frequencies and the bandwidth [Hz] set by the bandwidth setting unit 112 (step S303). The bandwidth setting unit 112 sets the bandwidth of the frequency band of interest in the frequency range set by the range setting unit 117.

BPF center frequency=fundamental rotation frequency [Hz]×n Equation 3

where n represents the natural number.

When the bandwidth setting unit 112 sets a bandwidth b [Hz], the BPF setting unit 111 calculates BPFs by the number of BPF center frequencies so as to satisfy Equation 4.

BPF center frequency−b/2≤BPF(n)≤BPF center frequency+b/2 Equation 4

where b represents the bandwidth.

Next, the band selection unit 113 (an example of a band pass filter selection unit) selects, from the plurality of BPFs, a BPF to be used for extracting feature information (step S304).

The band selection unit 113 selects one or more BPFs by a method of:
(a) selecting all;
(b) selecting overtones of TPF (TPF, 2×TPF, . . . ) and sideband waves thereof;
(c) selecting only sidebands of harmonics of the TPFs;
(d) selecting the fundamental rotation frequency and (b) or (c); and
(e) interactive selecting.

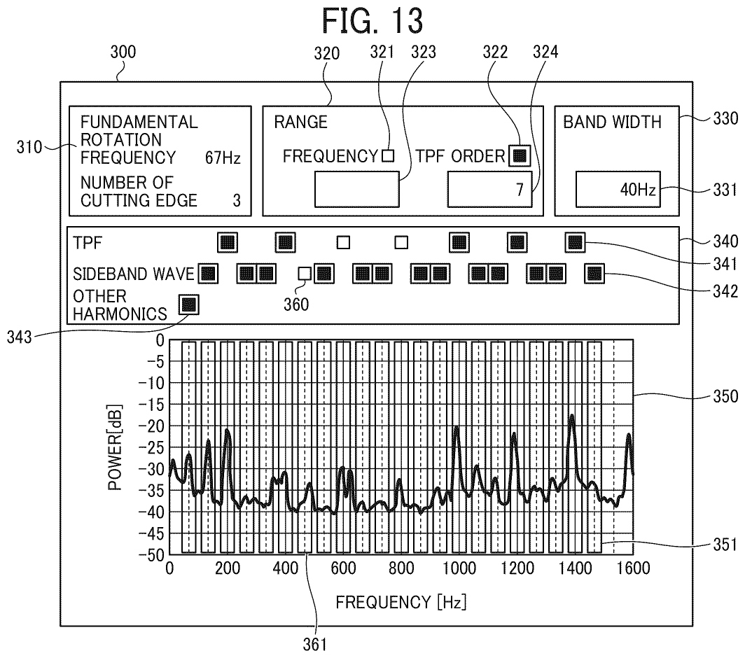

FIG. 13 is a diagram illustrating an example of a method for selecting one or more BPFs by the diagnostic apparatus according to the present embodiment. For example, to select the BPF by (e) interactive selecting, the display control unit 105 displays a BPF selection screen 500 on the display unit 106. The BPF selection screen 500 includes a context information display area 310, a range display area 320, a bandwidth display area 330, a band display area 340, and a data display area 350. In the context information display area 310, a fundamental rotation frequency and the number of cutting edges are displayed. In the range display area 320, a range set by the range setting unit 117 is displayed. In the bandwidth display area 330, a bandwidth set by the bandwidth setting unit 112 is displayed. In the band display area 340, a band selected by the band selection unit 113 is displayed.

The range display area 320 displays the upper limit frequency of the range set by the range setting unit 117. Specifically, the range display area 320 includes a frequency radio button 321, a TPF order radio button 322, a frequency input text box 323 into which the upper limit frequency can be input, and an order input text box 324 in which an upper limit frequency is input with the harmonic order of TPF. The user of the diagnostic apparatus 100 can exclusively input the upper limit frequency to the frequency input text box 323 and the order input text box 324. The frequency radio button 321 and the TPF order radio button 322 are configured so that the upper limit frequency is exclusively input to one of the frequency input text box 323 and the order input text box 324. In the range display area 320 illustrated in FIG. 13, the TPF harmonic order is input to the order input text box 324, and the second order TPF (2×TPF) is input as the upper limit frequency.

The bandwidth display area 330 includes a bandwidth input text box 331. In the bandwidth input text box 331 illustrated in FIG. 13, 40.0 Hz is set as the bandwidth. The data display area 350 displays an average spectrum which is obtained by averaging the plural spectra obtained by the frequency analysis on the in-machining waveform data used for learning of the model generation operation illustrated in FIG. 11 and is labeled as normal. The average spectrum displayed in the data display area 350 may be an average spectrum obtained from test in-machining waveform data processed by pseudo edge runout and labeled as abnormal. Alternatively, the average spectrum may be plural average spectra labeled as both normal and abnormal (e.g., average spectra illustrated in FIGS. 6 to 9).

The data display area 350 includes a BPF display area 351 that displays the BPF calculated in step S303 of FIG. 12. In the band display area 340, a TPF selection toggle button 341, a sideband wave selection toggle button 342, and a toggle button 343 are displayed so as to correspond to the BPFs displayed on the BPF display area 351. The TPF selection toggle button 341 is for selecting use of TPF for extraction of feature information. The sideband wave selection toggle button 342 is for selecting use of sideband waves for extraction of feature information. The toggle button 343 is for other harmonics. Among the TPF selection toggle button 341, the sideband wave selection toggle button 342, and the toggle button, one or more buttons used for extracting feature information in step S306 described later are turned on, and one or more buttons not used for extracting feature information are turned off.

Next, the natural frequency exclusion unit 118 excludes BPFs that include the natural frequencies of the machine 200 and the tool 223 from the BPFs set by the BPF setting unit 111 (step S305). The tool 223, the holder, the spindle 221, and the like have natural frequencies due to the shapes, sizes, and weights thereof. The frequency component of the natural frequency tends to be larger than the power of other frequency components regardless of whether the machining state of the machine 200 is normal or abnormal due to damage or runout of the cutting tool. Therefore, when the feature information includes the frequency component of the natural frequency, the determination accuracy of the machining state of the machine 200 decreases. Therefore, the natural frequency is input from the input unit 107 (the input device 158) in advance and stored in the memory 103 (e.g., the auxiliary memory 155). The natural frequency exclusion unit 118 retrieves the natural frequency from the memory 103 and excludes BPFs including the natural frequency from the BPFs calculated using Equation 4.

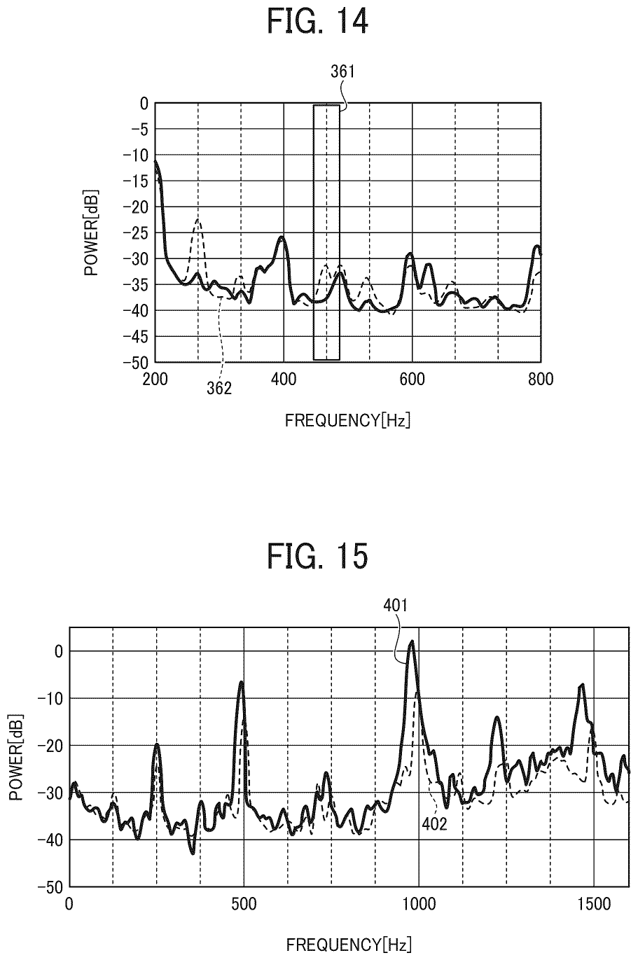

FIG. 14 is an enlarged view of the vicinity of the BPF of the average spectrum calculated by the diagnostic apparatus according to the present embodiment. In FIG. 14, the solid line represents the average spectrum, labeled as normal, in the vicinity of a BPF 361, and the broken line represents the average spectrum, labeled as abnormal, in the vicinity of the BPF 361.

Among the peaks of the average spectra illustrated in FIG. 14, a peak 362 is the natural frequency. When the BPF is selected by the above-described (e) interactive selecting, the user turns off the sideband wave selection toggle button 360 on the BPF selection screen 500, to exclude the selection methods (b) and (c). Alternatively, in the case of the above-described (a) selecting all and (e) interactive selecting, the BPF including the natural frequency is automatically excluded from the BPFs.

Referring back to FIG. 12, in S306, the feature extraction unit 110 extracts, as feature information of the average spectrum, the following power having a center frequency within the range of the BPF, from the powers of the average spectrum obtained by the Fourier transform. That is, the feature extraction unit 110 extracts feature information using the BPF selected by the band selection unit 113. For example, the feature extraction unit 110 sets the bandwidth to zero, selects the center frequency of the Fourier transform closest to the BPF center frequency of Equation 3, and extracts the power corresponding to the center frequency in the average spectrum as the feature information. The feature extraction unit 110 converts the amplitude or power extracted as feature information from the average spectrum into an optimum value according to the machining method such as a linear scale or a log scale (dB) or the tool type.

In step S105 in FIG. 10, similar to step S204 in FIG. 11, the frequency analysis unit 115 performs frequency-analysis on the predetermined number of samples in the in-machining waveform data while shifting the start position of the data string, using the FFT algorithm or the like. Thus, a data group having a three dimensional structure in which a plurality of spectra SPj (f) is arranged in time series is obtained. Here, j (=1 to J) is the number of spectra, and corresponds to the number of frequency analyses performed while shifting the start position of the data string.

Next, a first determination method of the machining state of the machine 200 will be described. In the first determination method, first, the feature extraction unit 110 calculates an average spectrum SP (f) of a plurality of spectra SPj (f). Next, the feature extraction unit 110 extracts the power or amplitude closest to the BPF center frequency in the average spectrum SP (f) as feature information. When the extracted feature information is the TPF and the harmonics thereof, the determining unit 102 compares the TPF and the harmonics thereof with respective thresholds set in advance for the TPF and the harmonics thereof. Then, the determining unit 102 determines that the machining state of the machine 200 is abnormal when the feature information is less than the threshold. When the extracted feature information is a sideband wave and a harmonic of another fundamental rotation frequency, the determining unit 102 compares the sideband wave and the harmonic with thresholds respectively set in advance for the sideband wave and the harmonic, and determines that the machining state of the machine 200 is abnormal when the feature information exceeds the threshold. Alternatively, when the extracted feature information is a sideband wave and harmonic of another fundamental rotation frequency, the determining unit 102 may calculate the rate of establishment that the feature information exceeds the threshold value, compare the establishment rate with a threshold value set in advance for the establishment rate, and determine that the machining state of the machine 200 is abnormal when the establishment rate exceeds the threshold value.

Next, a second determination method of the machining state of the machine 200 will be described. In the second determination method, the feature extraction unit 110 extracts feature information in the same manner as in the first determination method. Next, the determining unit 102 performs learning of one class support vector machine (SVM) using such multidimensional feature information, and determines whether or not the machining state of the machine 200 is abnormal by outlier detection.

Next, a third determination method of the machining state of the machine 200 will be described. In the third determination method, the determining unit 102 reads, from the memory 103, the learned model generated by the model generation operation illustrated in FIG. 11 (the learned model in the case of normal machining state of the machine 200). The learned model may be, for example, a probability density function P(X) such as a Gaussian mixture model (GMM). Here, X (={x1, x2, xn}) is an n-dimensional feature value extracted according to the BPF when the learned model is trained. The BPF is stored in the memory 103 with the learned model. In step S106 of FIG. 10, the feature value of each of the plurality of spectra SPj (f) is extracted using the BPF.

In step S107 of FIG. 10, the determining unit 102 determines that the machining state of the machine 200 is normal when the likelihood obtained by inputting the feature value to the probability density function P(X) is equal to or greater than a threshold value, and determines that the machining state of the machine 200 is abnormal when the likelihood is less than the threshold value. Alternatively, as expressed in Equation 5 below, the determining unit 102 defines a value obtained by reversing the sign of the log likelihood as an abnormality degree score aj, sets the value as an index value such that the abnormality degree score increases when the abnormal state of the machine 200 is strong, and obtains the abnormality degree score aj by the number j=1 to J of spectra.

aj=−log (P(Xj)) Equation 5

The determining unit 102 selects, as the total score of the abnormality degree score aj, for example, as illustrated in Equation 6, the maximum value, the average, or a value suitable for the tool or the machining method, of the abnormality degree scores aj.

A=(Σaj)/J Equation 6

Then, the determining unit 102 compares the abnormality degree score aj with the threshold set in advance, determines that the machining state of the machine 200 is abnormal when the abnormality degree score aj is equal to or greater than the threshold, and determines that the machining state of the machine 200 is normal when the abnormality degree score aj is less than the threshold.

Next, a description is given below of an operation of the diagnostic apparatus 100 in the above-described contouring processing. The contouring processing is performed under conditions that the runout of the cutting edge of the end mill is adjusted to 2.0 μm or less, and the rotation speed of the XY-axes stage 225 is increased to 520.0 mm/min, without changing other conditions.

The feature extraction unit 110 extracts data of a machining section having a depth of cut of 200.0 μm from the detection results received from the machine 200, and obtains an average spectrum by frequency analysis illustrated in step S204 of FIG. 11.

FIG. 15 is a graph illustrating examples of the average spectra obtained by frequency analysis by the diagnostic apparatus according to the present embodiment. In FIG. 15, the solid line represents an average spectrum obtained in the experiment in which the machine 200 performed machining under the above-described machining conditions, and the broken line represents an average spectrum labeled as normal. As described above, the machining conditions differ only in the rotation speed (90.0 mm/min) of the XY-axes stage 225.

When the rotation speed of the XY-axes stage 225 increases, the harmonics of the fundamental rotation frequency (and the TPF) shift to the lower frequency side. The shift of the fundamental rotation frequency (125.0 Hz) is about 3.0 Hz, and the shift of the harmonics of the TPF (=1000.0 Hz) is about 25.0 Hz. The shift of the fundamental rotation frequency and the TPF is caused in a fact that the cutting edge cuts the workpiece while changing the contact position with the arc surface of the rough hole of the workpiece due to the rotation of the XY-axes stage 225.

In step S106 of FIG. 10 and step S205 of FIG. 11, correct feature information is not extracted by the BPFs mismatched with the shift of the fundamental rotation frequencies, and the determination result of the machining state of the machine 200 is unreliable. Therefore, when a shifted fundamental rotation frequency F is obtained, the fundamental rotation frequencies in Equations 2 to 4 can be replaced with the shifted fundamental rotation frequency F, and the BPF can be calculated. In the present embodiment, the frequency shift estimation unit 114 corrects the fundamental rotation frequency using the frequency analysis result (for example, average spectrum) of the detection result by the frequency analysis unit 115 and the rotation information, and calculates the shifted fundamental rotation frequency F.

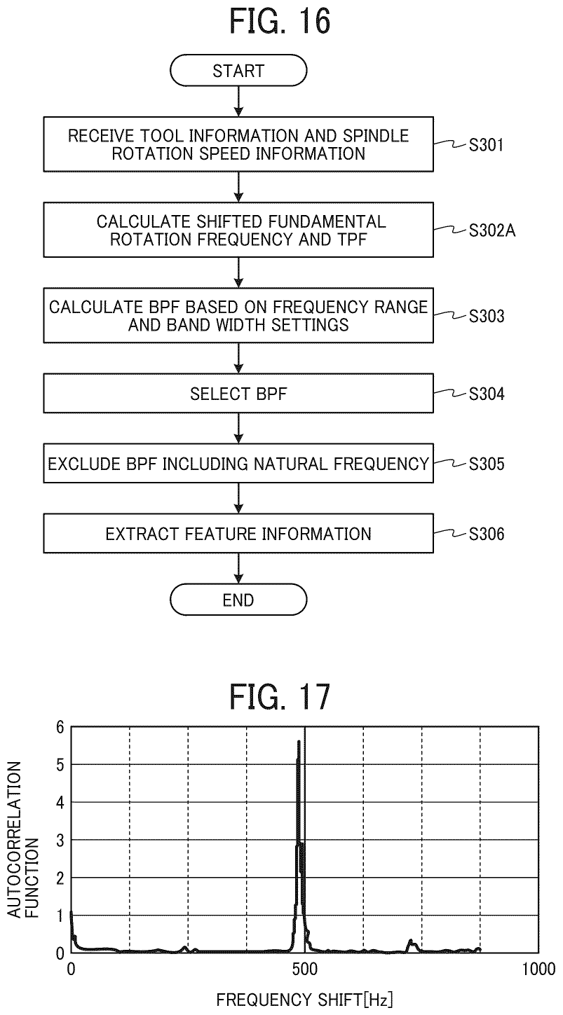

FIG. 16 is a flowchart illustrating another example of the sequence of the feature information extraction operation in accordance with the BPF, performed by the diagnostic apparatus according to the present embodiment. In the sequence of the feature information extraction operation in FIG. 16, the operation in step S302 of FIG. 12 is replaced with the operation in step S302A. In step S302A, the BPF setting unit 111 calculates the shifted fundamental rotation frequencies F and the TPF.

Next, a description is given below of an example of correction of the fundamental rotation frequency in the diagnostic apparatus 100 according to the present embodiment. As illustrated in FIG. 15, the average spectrum has large peaks in the TPF and the harmonic components thereof. The frequency shift estimation unit 114 searches for a frequency at which the average spectrum has the maximum in the vicinity of the TPF obtained in step S302 illustrated in FIG. 12 and frequencies that are integral multiples of the TPF, and corrects the fundamental rotation frequency based on the found frequency. Alternatively, the frequency shift estimation unit 114 may appropriately mix the fundamental rotation frequency obtained in step S302 and frequencies of integral multiples thereof.

For example, the frequency shift estimation unit 114 divides the obtained frequencies by respective integer values used as references and sets an average value thereof as corrected fundamental rotation frequencies. Alternatively, the frequency shift estimation unit 114 may plot the integer value on the horizontal axis and the found frequency on the vertical axis, and obtain the slope by least squares.

Next, a description is given below of another example of correction of the fundamental rotation frequency in the diagnostic apparatus 100 according to the present embodiment. When the fundamental rotation frequency f is obtained from the spindle rotation speed included in the context information according to Equation 1, in an average spectrum 401 illustrated in FIG. 15, the fundamental rotation frequency f is 125.0 Hz. The frequency shift estimation unit 114 obtains the autocorrelation function of the average spectrum 401 illustrated in FIG. 15 by using Equation 7 below. FIG. 17 is a graph illustrating an example of the autocorrelation function obtained by the diagnostic apparatus according to the present embodiment.

$$R ( h ) = \frac{1}{( n - h ) {σ}^{2}} {\sum }_{i = 1}^{n - h} ( SP ( i ) - μ ) ( SP ( i + h ) - μ ) \qquad Equation 7$$

where SP (i) represents the spectrum, μ represents the average spectrum, σ² represents the dispersion of the spectrum, and h represents the shift amount (frequency shift) of the fundamental rotation frequency.

Since the autocorrelation of the spectrum is obtained, harmonics is identified. As the shift amount h, an index having an upper limit frequency of 7f=875.0 Hz is selected. Therefore, n is an index with which the upper limit frequency is 14f=1750.0 Hz. As illustrated in FIG. 15, it can be seen that the power of the average spectrum increases in the TPF and the harmonic components thereof. Therefore, the autocorrelation function illustrated in FIG. 17 is also maximized at h=TPF (h takes both plus and minus values). Assuming that h at this time is H, Equation 8 holds.

F=H/t Equation 8

Further, the frequency shift estimation unit 114 also estimates the number of cutting edges t based on the fundamental rotation frequency f obtained from the context information as expressed in Equation 9.

T=round(H/f) Equation 9

where round( ) is a function that rounds an argument to a nearest integer.

That is, the frequency shift estimation unit 114 calculates an autocorrelation function of the frequency analysis result of the detection result, and obtains a delay value at which the autocorrelation function returns the maximum value. The delay value obtained is in a range greater than the corrected fundamental rotation frequency when h takes a plus value and in a range smaller than the corrected fundamental rotation frequency when h takes a minus value. Next, the frequency shift estimation unit 114 estimates the number of cutting edges of the tool 223 using the obtained delay value. Then, the BPF setting unit 111 sets the BPF by using the plurality of BPF center frequencies set (calculated) by using the estimated number of cutting edges instead of the tool information.

As described above, the machining system according to the present embodiment determines the machining state of the machine 200 using the feature information extracted in accordance with the tool 223 or the type of machining. Thus, the machining system detects and monitors the occurrence of an abnormality in the machining of the machine 200 with high accuracy for various types of machining performed in the machining center.

According to one aspect of the present disclosure, the machining system executes a method for diagnosing a machining state of a machine. The method includes receiving context information defining an operation of a tool attached to a spindle of the machine, rotation information of the spindle, tool information identifying the tool, and a detection result of a time-varying physical quantity. The time-varying physical quantity is generated by the tool executing a machining operation on a workpiece. The method further includes performing frequency analysis on the detection result, setting a frequency range, setting a bandwidth of a frequency band to be noted in the frequency range, and setting a band pass filter using a plurality of center frequencies and the bandwidth. The plurality of center frequencies is set using the rotation information, the tool information, and the frequency range. The method further includes extracting feature information from the detection result using the band pass filter and a frequency analysis result of the detection result, and determining the machining state of the machine using the feature information. According to another aspect, the machining system executes computer readable codes carried on carrier means, for controlling a computer to carry out the above-described method.

Note that the computer programs performed in the diagnostic apparatus 100 according to the above-described embodiments may be preliminarily installed in a memory such as the ROM 152. The program executed by the diagnostic apparatus 100 according to the present embodiment may be stored in a computer-readable recording medium, such as a compact disc read-only memory (CD-ROM), a flexible disk (FD), a compact disc recordable (CD-R), and a digital versatile disk (DVD), in an installable or executable file format, to be provided as a computer program product.

Alternatively, the computer programs executed in the diagnostic apparatus 100 according the above-described embodiment can be stored in a computer connected to a network such as the Internet and downloaded through the network. Alternatively, the computer programs executed in the diagnostic apparatus 100 according to the above-described embodiment can be provided or distributed via a network such as the Internet.

The program executed by the diagnostic apparatus 100 according to the above-described embodiment are in a modular configuration including the above-described communication control unit 101, the determining unit 102, the generation unit 104, the display control unit 105, the feature extraction unit 110, and the receiving unit 120. As hardware, as the CPU 151 (an example of a processor) reads the program from the ROM 152 and executes the program, the above-described functional units are loaded and implemented (generated) in a main memory. Alternatively, each hardware of the diagnostic apparatus 100 of the above-described embodiment may be incorporated into the machine 200 such that the machine 200 executes the above-described program as a machine having the diagnostic function.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The present invention can be implemented in any convenient form, for example using dedicated hardware, or a mixture of dedicated hardware and software. The present invention may be implemented as computer software implemented by one or more networked processing apparatuses. The processing apparatuses include any suitably programmed apparatuses such as a general purpose computer, a personal digital assistant, a Wireless Application Protocol (WAP) or third-generation (3G)-compliant mobile telephone, and so on. Since the present invention can be implemented as software, each and every aspect of the present invention thus encompasses computer software implementable on a programmable device. The computer software can be provided to the programmable device using any conventional carrier medium (carrier means). The carrier medium includes a transient carrier medium such as an electrical, optical, microwave, acoustic or radio frequency signal carrying the computer code. An example of such a transient medium is a Transmission Control Protocol (TCP)/Internet Protocol (IP) signal carrying computer code over an IP network, such as the Internet. The carrier medium also includes a storage medium for storing processor readable code such as a floppy disk, a hard disk, a compact disc read-only memory (CD-ROM), a magnetic tape device, or a solid state memory device.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), a digital signal processor (DSP), a field programmable gate array (FPGA), and conventional circuit components arranged to perform the recited functions.

This patent application is based on and claims priority to Japanese Patent Application No. 2020-181869, filed on Oct. 29, 2020, in the Japan Patent Office, the entire disclosure of which is hereby incorporated by reference herein.

### REFERENCE SIGNS LIST

100 Diagnostic apparatus
101 Communication control unit
101a Receiving unit
101b Transmitting unit
102 Determining unit
103 Memory
104 Generation unit
105 Display control unit
106 Display
107 Input unit
110 Feature extraction unit
111 Band pass filter setting unit (BPF setting unit)
112 Bandwidth setting unit
113 Band selection unit
114 Frequency shift estimation unit
115 Frequency analysis unit
116 Machining waveform extraction unit
117 Range setting unit
118 Natural frequency exclusion unit
120 Receiving unit
121 Tool information receiving unit
122 Spindle rotation speed receiving unit
123 Machining process receiving unit
200 Machine
205 Communication control unit
221 Spindle
223 Tool
227 Physical quantity information detection unit

1. A diagnostic apparatus comprising:
a memory having computer readable instructions stored thereon; and
processing circuitry configured to execute the computer readable instructions to,
receive context information defining an operation of a tool attached to a spindle of a machine, rotation information of the spindle, tool information identifying the tool, and a detection result of a time-varying physical quantity, the time-varying physical quantity being generated by the tool during at least one machining operation performed by the machine on a workpiece;
determine a frequency analysis result by performing frequency analysis on the detection result;
set a frequency range;
set a bandwidth of a frequency band to be noted in the frequency range;
set a band pass filter using a plurality of center frequencies and the bandwidth, the plurality of center frequencies being set using the rotation information, the tool information, and the frequency range;
extract feature information from the detection result using the band pass filter and the frequency analysis result; and
determine a machining state of the machine using the feature information.

2. The diagnostic apparatus according to claim 1, wherein the processing circuitry is further configured to:
generate a model by learning of the feature information; and
determine the machining state using the model.

3. The diagnostic apparatus according to claim 1, wherein the processing circuitry is further configured to:
calculate a plurality of band pass filters using the plurality of center frequencies and the bandwidth;
select, from the plurality of band pass filters, the band pass filter to be used for extracting the feature information; and
extract the feature information using the selected band pass filter.

4. The diagnostic apparatus according to claim 1, wherein the processing circuitry is further configured to:
calculate a plurality of band pass filters using the plurality of center frequencies and the bandwidth; and
exclude, from the plurality of band pass filters, a band pass filter including a natural frequency of the machine and a natural frequency of the tool.

5. The diagnostic apparatus according to claim 1, wherein
the plurality of center frequencies includes:
a fundamental rotation frequency calculated using the rotation information, and
a frequency that is an integral multiple of the fundamental rotation frequency; and
the processing circuitry is further configured to correct the fundamental rotation frequency using the frequency analysis result and the rotation information.

6. A machining system comprising:
a machine configured to perform at least one machining operation on a workpiece using a tool attached to a spindle of the machine, the machine including a transmitter configured to transmit context information defining an operation of the tool attached to the spindle of the machine, rotation information of the spindle, tool information identifying the tool, and a detection result of a time-varying physical quantity, the time-varying physical quantity being generated by the tool during the at least one machining operation; and
a diagnostic apparatus, the diagnostic apparatus configured to,
receive the context information, the rotation information, the tool information, and the detection result,
determine a frequency analysis result by performing frequency analysis on the detection result,
set a frequency range,
set a bandwidth of a frequency band to be noted in the frequency range,
set a band pass filter using a plurality of center frequencies and the bandwidth, the plurality of center frequencies being set using the rotation information, the tool information, and the frequency range,
extract feature information from the detection result using the band pass filter and the frequency analysis result, and
determine a machining state of the machine using the feature information.

7. A method for diagnosing a machining state of a machine, the method comprising:
receiving context information defining an operation of a tool attached to a spindle of the machine, rotation information of the spindle, tool information identifying the tool, and a detection result of a time-varying physical quantity, the time-varying physical quantity being generated by the tool during at least one machining operation performed by the machine on a workpiece;
determining a frequency analysis result by performing frequency analysis on the detection result;
setting a frequency range;
setting a bandwidth of a frequency band to be noted in the frequency range;
setting a band pass filter using a plurality of center frequencies and the bandwidth, the plurality of center frequencies being set using the rotation information, the tool information, and the frequency range;
extracting feature information from the detection result using the band pass filter and the frequency analysis result; and
determining the machining state of the machine using the feature information.

8. The method according to claim 7, further comprising:
generating a model by learning of the feature information; and
the determining the machine state includes determining the machining state using the model.

9. The method according to claim 7, wherein the setting the band pass filter includes:
setting the plurality of center frequencies by calculating a fundamental rotation frequency using the rotation informations, and setting a frequency that is an integral multiple of the fundamental rotation frequency.

10. The method according to claim 7, wherein the setting the band pass filter includes:
setting the plurality of center frequencies by calculating a tool passing frequency using a fundamental rotation frequency and a number of cutting edges in the tool information, the fundamental rotation frequency being calculated using the rotation information, and setting a sideband wave of an integral multiple of the tool passing frequency.

11. The method according to claim 7, wherein
the setting the band pass filter includes:
setting a plurality of band pass filters using the plurality of center frequencies and the bandwidth, and
selecting, from the plurality of band pass filters, the band pass filter to be used for extracting the feature information; and
the extracting the feature information further includes extracting the feature information from the detection result using the selected band pass filter.

12. The method according to claim 9, further comprising:
calculating an autocorrelation function of the frequency analysis result;
obtaining a delay value of the autocorrelation function, the delay value at which the autocorrelation function returns a maximum value, the delay value being greater than the fundamental rotation frequency; and
estimating a number of cutting edges of the tool using the delay values; and
the setting the band pass filter further includes setting the plurality of center frequencies using the estimated number of cutting edges as the tool information.

13. The method according to claim 8, wherein the determining the machining state includes:
calculating a likelihood that the feature information is normal using the model; and
determining the machining state by comparing at least one of the likelihood or a value calculated using the likelihood with a desired threshold.

14. A non-transitory computer readable recording medium including computer readable code, which when executed by processing circuitry, causes the processing circuitry to execute the method according to claim 7.
